(19) United States
(12) Patent Application Publication
(10) Pub. No.: US 2018/0348720 A1
(43) Pub. Date: Dec. 6, 2018

(54) Active Energy Budget Control Management

(71) Applicant: Trane International Inc., Davidson, NC (US)

(72) Inventor: Kirby Neal Bicknell, Tyler, TX (US)

(21) Appl. No.: 16/044,243

(22) Filed: Jul. 24, 2018

Related U.S. Application Data
(63) Continuation of application No. 14/587,366, filed on Dec. 31, 2014, now abandoned.
(60) Provisional application No. 61/926,787, filed on Jan. 13, 2014.

(51) Int. Cl. G05B 15/02

(52) U.S. Cl. CPC G05B 15/02; G05B 2219/2642

(57) ABSTRACT

A heating, ventilation, and/or air conditioning (HVAC) system includes a system controller configured to receive an input of an energy budget for the HVAC system for a specified period of time, determine a set point for the HVAC system that will cause an amount of energy used in operating the HVAC system over the specified period of time to meet the energy budget, and operate the HVAC system at the determined set point.

### CROSS-REFERENCE TO RELATED APPLICATIONS

The present application is a continuation of U.S. patent application Ser. No. 14/587,366 filed Dec. 31, 2014 by Kirby Neal Bicknell entitled, “Active Energy Budget Control Management”, which claims priority to U.S. Provisional Patent Application No. 61/926,787 filed Jan. 13, 2014 by Kirby Neal Bicknell entitled, “Active Energy Budget Control Management”, both of which are incorporated by reference herein as if reproduced in their entirety.

### STATEMENT REGARDING FEDERALLY SPONSORED RESEARCH OR DEVELOPMENT

Not Applicable.

### REFERENCE TO A MICROFICHE APPENDIX

Not applicable.

### BACKGROUND

Heating, ventilation, and air conditioning systems (HVAC systems) may be used to heat and/or cool comfort zones to comfortable temperatures. Comfort zones are often the occupiable portions of residential and/or commercial areas and may be subject to variable zone conditions, such as temperature and humidity. A portion of an HVAC system may be installed outdoors or in some other location remote from the comfort zone for the purpose of performing heat exchange. Such a location may be referred to as an ambient zone and may also have variable temperature and humidity conditions.

Some HVAC systems are heat pump systems. Heat pump systems are generally capable of operating in a cooling mode in which a comfort zone is cooled by transferring heat from the comfort zone to an ambient zone using a refrigeration cycle (e.g., the Rankine cycle). Heat pump systems are also generally capable of operating in a heating mode in which the direction of refrigerant flow through the components of the HVAC system is reversed so that heat is transferred from the ambient zone to the comfort zone, thereby heating the comfort zone. Heat pump systems generally use a reversing valve for rerouting the direction of refrigerant flow between the compressor and the heat exchangers associated with the comfort zone and the ambient zone.

### SUMMARY

In an embodiment, a method of operating a heating, ventilation, and/or air conditioning (HVAC) system is provided. The method comprises receiving an input of an energy budget for the HVAC system for a specified period of time; determining a set point for the HVAC system that will cause an amount of energy used in operating the HVAC system over the specified period of time to meet the energy budget; and operating the HVAC system at the set point.

In another embodiment, a system controller for a heating, ventilation, and/or air conditioning (HVAC) system is provided. The system controller comprises a processor configured such that the system controller receives an input of an energy budget for the HVAC system for a specified period of time, determines a set point for the HVAC system that will cause an amount of energy used in operating the HVAC system over the specified period of time to meet the energy budget, and operates the HVAC system at the set point.

In another embodiment, a heating, ventilation, and/or air conditioning (HVAC) system is provided. The HVAC system comprises a system controller configured to operate the HVAC system at a set point determined by the system controller based on an energy budget entered into the system controller.

### BRIEF DESCRIPTION OF THE DRAWINGS

FIG. 1 is a schematic diagram of an HVAC system according to an embodiment of the disclosure;

FIG. 2 is a schematic diagram of the air circulation paths of the HVAC system of FIG. 1;

FIG. 3 is a schematic diagram of inputs into an HVAC system controller;

FIG. 4 is a flowchart of a method for operating an HVAC system; and

FIG. 5 is a representation of a general-purpose processor (e.g., electronic controller or computer) system suitable for implementing the embodiments of the disclosure.

### DETAILED DESCRIPTION

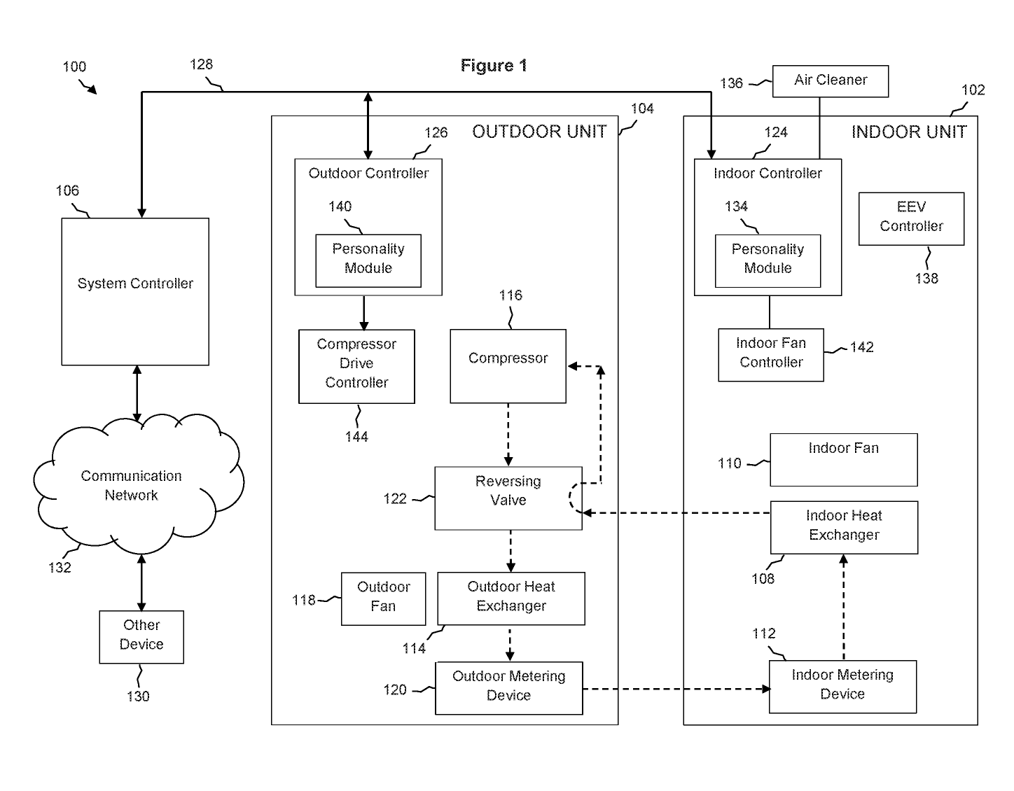

FIG. 1 is a schematic diagram of an HVAC system 100 according to an embodiment of this disclosure. HVAC system 100 comprises an indoor unit 102, an outdoor unit 104, and a system controller 106. In some embodiments, the system controller 106 may operate to control operation of the indoor unit 102 and/or the outdoor unit 104. As shown, the HVAC system 100 is a so-called heat pump system that may be selectively operated to implement one or more substantially closed thermodynamic refrigeration cycles to provide a cooling functionality and/or a heating functionality. In other embodiments, the HVAC system 100 may be some other type of heating, ventilation, and/or air conditioning system.

The indoor unit 102 comprises an indoor heat exchanger 108, an indoor fan 110, and an indoor metering device 112. The indoor heat exchanger 108 may be a plate fin heat exchanger configured to allow heat exchange between refrigerant carried within internal tubing of the indoor heat exchanger 108 and fluids that contact the indoor heat exchanger 108 but that are kept segregated from the refrigerant. In other embodiments, the indoor heat exchanger 108 may comprise a spine fin heat exchanger, a microchannel heat exchanger, or any other suitable type of heat exchanger.

The indoor fan 110 may be a centrifugal blower comprising a blower housing, a blower impeller at least partially disposed within the blower housing, and a blower motor configured to selectively rotate the blower impeller. In other embodiments, the indoor fan 110 may comprise a mixed-flow fan and/or any other suitable type of fan. The indoor fan 110 may be configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, the indoor fan 110 may be a single speed fan.

The indoor metering device 112 may be an electronically controlled motor driven electronic expansion valve (EEV). In alternative embodiments, the indoor metering device 112 may comprise a thermostatic expansion valve, a capillary tube assembly, and/or any other suitable metering device. The indoor metering device 112 may comprise and/or be associated with a refrigerant check valve and/or refrigerant bypass for use when a direction of refrigerant flow through the indoor metering device 112 is such that the indoor metering device 112 is not intended to meter or otherwise substantially restrict flow of refrigerant through the indoor metering device 112.

The outdoor unit 104 comprises an outdoor heat exchanger 114, a compressor 116, an outdoor fan 118, an outdoor metering device 120, and a reversing valve 122. The outdoor heat exchanger 114 may be a spine fin heat exchanger configured to allow heat exchange between refrigerant carried within internal passages of the outdoor heat exchanger 114 and fluids that contact the outdoor heat exchanger 114 but that are kept segregated from the refrigerant. In other embodiments, the outdoor heat exchanger 114 may comprise a plate fin heat exchanger, a microchannel heat exchanger, or any other suitable type of heat exchanger.

The compressor 116 may be a multiple speed scroll type compressor configured to selectively pump refrigerant at a plurality of mass flow rates. In alternative embodiments, the compressor 116 may be a modulating compressor capable of operation over one or more speed ranges, a reciprocating type compressor, a single speed compressor, and/or any other suitable refrigerant compressor and/or refrigerant pump.

The outdoor fan 118 may be an axial fan comprising a fan blade assembly and fan motor configured to selectively rotate the fan blade assembly. In other embodiments, the outdoor fan 118 may comprise a mixed-flow fan, a centrifugal blower, and/or any other suitable type of fan and/or blower. The outdoor fan 118 may be configured as a modulating and/or variable speed fan capable of being operated at many speeds over one or more ranges of speeds. In other embodiments, the outdoor fan 118 may be configured as a multiple speed fan capable of being operated at a plurality of operating speeds by selectively electrically powering different ones of multiple electromagnetic windings of a motor of the outdoor fan 118. In yet other embodiments, the outdoor fan 118 may be a single speed fan.

The outdoor metering device 120 may be a thermostatic expansion valve. In alternative embodiments, the outdoor metering device 120 may comprise an electronically controlled motor driven EEV, a capillary tube assembly, and/or any other suitable metering device. The outdoor metering device 120 may comprise and/or be associated with a refrigerant check valve and/or refrigerant bypass for use when a direction of refrigerant flow through the outdoor metering device 120 is such that the outdoor metering device 120 is not intended to meter or otherwise substantially restrict flow of refrigerant through the outdoor metering device 120.

The reversing valve 122 may be a so-called four-way reversing valve. The reversing valve 122 may be selectively controlled to alter a flow path of refrigerant in the HVAC system 100 as described in greater detail below. The reversing valve 122 may comprise an electrical solenoid or other device configured to selectively move a component of the reversing valve 122 between operational positions.

The system controller 106 may comprise a touchscreen interface for displaying information and for receiving user inputs. The system controller 106 may display information related to the operation of the HVAC system 100 and may receive user inputs related to operation of the HVAC system 100. The system controller 106 may further be operable to display information and receive user inputs tangentially related and/or unrelated to operation of the HVAC system 100. In some embodiments, the system controller 106 may comprise a temperature sensor and may further be configured to control heating and/or cooling of zones associated with the HVAC system 100. In some embodiments, the system controller 106 may be configured as a thermostat for controlling the supply of conditioned air to zones associated with the HVAC system 100.

In some embodiments, the system controller 106 may selectively communicate with an indoor controller 124 of the indoor unit 102, with an outdoor controller 126 of the outdoor unit 104, and/or with other components of the HVAC system 100. In some embodiments, the system controller 106 may be configured for selective bidirectional communication over a communication bus 128. In some embodiments, portions of the communication bus 128 may comprise a three-wire connection suitable for communicating messages between the system controller 106 and one or more of the HVAC system components configured for interfacing with the communication bus 128.

Still further, the system controller 106 may be configured to selectively communicate with HVAC system components and/or another device 130 via a communication network 132. In some embodiments, the communication network 132 may comprise a telephone network and the other device 130 may comprise a telephone. In some embodiments, the communication network 132 may comprise the Internet and the other device 130 may comprise a so-called smartphone and/or other Internet-enabled mobile telecommunication device.

The indoor controller 124 may be carried by the indoor unit 102 and may be configured to receive information inputs, transmit information outputs, and otherwise communicate with the system controller 106, the outdoor controller 126, and/or any other device via the communication bus 128 and/or any other suitable medium of communication. In some embodiments, the indoor controller 124 may be configured to communicate with an indoor personality module 134, receive information related to a speed of the indoor fan 110, transmit a control output to an electric heat relay, transmit information regarding an indoor fan volumetric flow rate, communicate with and/or otherwise affect control over an air cleaner 136, and communicate with an indoor EEV controller 138. In some embodiments, the indoor controller 124 may be configured to communicate with an indoor fan controller 142 and/or otherwise affect control over operation of the indoor fan 110. In some embodiments, the indoor personality module 134 may comprise information related to the identification and/or operation of the indoor unit 102 and/or a position of the outdoor metering device 120.

In some embodiments, the indoor EEV controller 138 may be configured to receive information regarding temperatures and pressures of the refrigerant in the indoor unit 102. More specifically, the indoor EEV controller 138 may be configured to receive information regarding temperatures and pressures of refrigerant entering, exiting, and/or within the indoor heat exchanger 108. Further, the indoor EEV controller 138 may be configured to communicate with the indoor metering device 112 and/or otherwise affect control over the indoor metering device 112.

The outdoor controller 126 may be carried by the outdoor unit 104 and may be configured to receive information inputs, transmit information outputs, and otherwise communicate with the system controller 106, the indoor controller 124, and/or any other device via the communication bus 128 and/or any other suitable medium of communication. In some embodiments, the outdoor controller 126 may be configured to communicate with an outdoor personality module 140 that may comprise information related to the identification and/or operation of the outdoor unit 104. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 126 may be configured to transmit information related to monitoring, communicating with, and/or otherwise affecting control over the outdoor fan 118, a compressor sump heater, a solenoid of the reversing valve 122, a relay associated with adjusting and/or monitoring a refrigerant charge of the HVAC system 100, a position of the indoor metering device 112, and/or a position of the outdoor metering device 120. The outdoor controller 126 may further be configured to communicate with a compressor drive controller 144 that is configured to electrically power and/or control the compressor 116.

The HVAC system 100 is shown configured for operating in a so-called cooling mode in which heat is absorbed by refrigerant at the indoor heat exchanger 108 and heat is rejected from the refrigerant at the outdoor heat exchanger 114. In some embodiments, the compressor 116 may be operated to compress refrigerant and pump the relatively high temperature and high pressure compressed refrigerant from the compressor 116 through the reversing valve 122 to the outdoor heat exchanger 114. As the refrigerant is passed through the outdoor heat exchanger 114, the outdoor fan 118 may be operated to move air into contact with the outdoor heat exchanger 114, thereby transferring heat from the refrigerant to the air surrounding the outdoor heat exchanger 114. The refrigerant may primarily comprise liquid phase refrigerant and the refrigerant may be pumped from the outdoor heat exchanger 114 to the indoor metering device 112 through and/or around the outdoor metering device 120, which does not substantially impede flow of the refrigerant in the cooling mode. The indoor metering device 112 may meter passage of the refrigerant through the indoor metering device 112 so that the refrigerant downstream of the indoor metering device 112 is at a lower pressure than the refrigerant upstream of the indoor metering device 112. The pressure differential across the indoor metering device 112 allows the refrigerant downstream of the indoor metering device 112 to expand and/or at least partially convert to a gaseous phase. The gaseous phase refrigerant may enter the indoor heat exchanger 108. As the refrigerant is passed through the indoor heat exchanger 108, the indoor fan 110 may be operated to move air into contact with the indoor heat exchanger 108, thereby transferring heat to the refrigerant from the air surrounding the indoor heat exchanger 108. The refrigerant may thereafter reenter the compressor 116 after passing through the reversing valve 122.

To operate the HVAC system 100 in the so-called heating mode, the reversing valve 122 may be controlled to alter the flow path of the refrigerant, the indoor metering device 112 may be disabled and/or bypassed, and the outdoor metering device 120 may be enabled. In the heating mode, refrigerant may flow from the compressor 116 to the indoor heat exchanger 108 through the reversing valve 122. The refrigerant may be substantially unaffected by the indoor metering device 112 and may experience a pressure differential across the outdoor metering device 120. The refrigerant may pass through the outdoor heat exchanger 114 and reenter the compressor 116 after passing through the reversing valve 122. In general, operation of the HVAC system 100 in the heating mode reverses the roles of the indoor heat exchanger 108 and the outdoor heat exchanger 114 as compared to their operation in the cooling mode.

The HVAC system 100 is shown as a so-called split system, wherein the indoor unit 102 is located separately from the outdoor unit 104. Alternative embodiments of an HVAC system may comprise a so-called package system in which one or more of the components of the indoor unit 102 and one or more of the components of the outdoor unit 104 are carried together in a common housing or package. The HVAC system 100 is shown as a so-called ducted system where the indoor unit 102 is located remote from the conditioned zones, thereby requiring air ducts to route the circulating air. However, in alternative embodiments, an HVAC system may be configured as a non-ducted system in which the indoor unit 102 and/or multiple indoor units 102 associated with an outdoor unit 104 are located substantially in the space and/or zone to be conditioned by the respective indoor units 102, thereby not requiring air ducts to route the air conditioned by the indoor units 102.

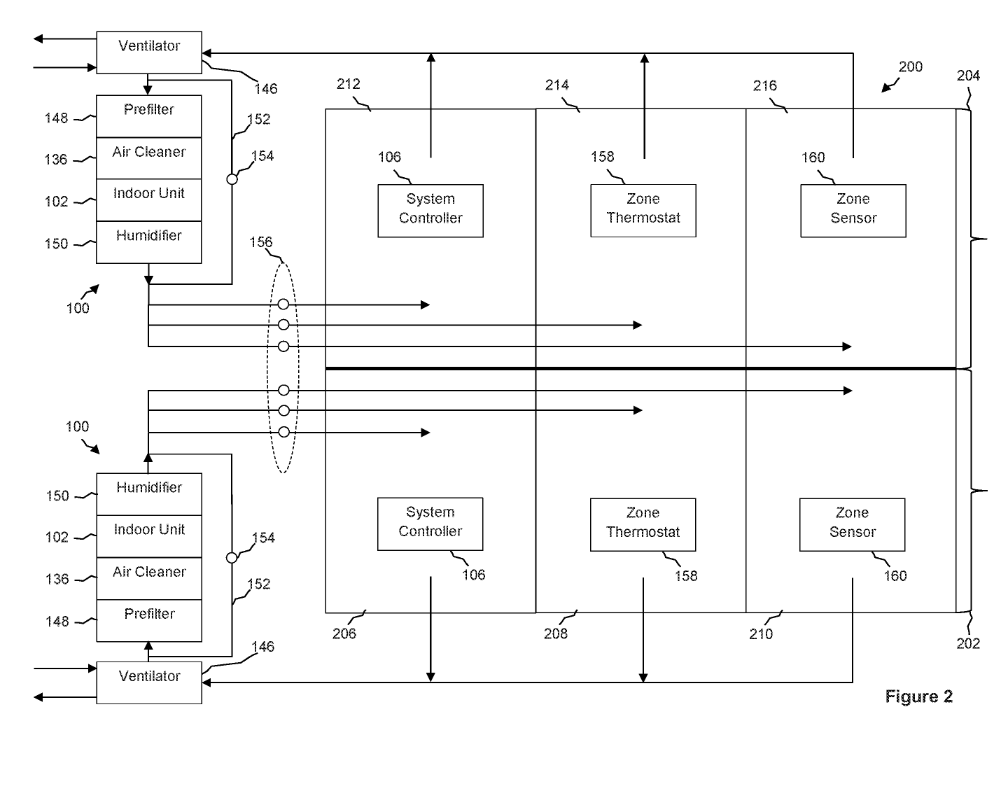

Referring now to FIG. 2, a simplified schematic diagram of the air circulation paths for a structure 200 conditioned by two HVAC systems 100 is shown. In this embodiment, the structure 200 is conceptualized as comprising a lower floor 202 and an upper floor 204. The lower floor 202 comprises zones 206, 208, and 210, while the upper floor 204 comprises zones 212, 214, and 216. The HVAC system 100 associated with the lower floor 202 is configured to circulate and/or condition air of lower zones 206, 208, and 210, while the HVAC system 100 associated with the upper floor 204 is configured to circulate and/or condition air of upper zones 212, 214, and 216.

In addition to the components of the HVAC system 100 described above, in this embodiment, each HVAC system 100 further comprises a ventilator 146, a prefilter 148, a humidifier 150, and a bypass duct 152. The ventilator 146 may be operated to selectively exhaust circulating air to the environment and/or introduce environmental air into the circulating air. The prefilter 148 may generally comprise a filter medium selected to catch and/or retain relatively large particulate matter prior to air exiting the prefilter 148 and entering the air cleaner 136. The humidifier 150 may be operated to adjust the humidity of the circulating air. The bypass duct 152 may be utilized to regulate air pressures within the ducts that form the circulating air flow paths. In some embodiments, air flow through the bypass duct 152 may be regulated by a bypass damper 154, while air flow delivered to the zones 206, 208, 210, 212, 214, and 216 may be regulated by zone dampers 156.

Each HVAC system 100 may further comprise a zone thermostat 158 and a zone sensor 160. In some embodiments, a zone thermostat 158 may communicate with the system controller 106 and may allow a user to control a temperature, humidity, and/or other environmental setting for the zone in which the zone thermostat 158 is located. Further, the zone thermostat 158 may communicate with the system controller 106 to provide temperature, humidity, and/or other environmental feedback regarding the zone in which the zone thermostat 158 is located. In some embodiments, a zone sensor 160 may communicate with the system controller 106 to provide temperature, humidity, and/or other environmental feedback regarding the zone in which the zone sensor 160 is located.

The system controllers 106 may be configured for bidirectional communication with each other and may further be configured so that a user may, using either of the system controllers 106, monitor and/or control any of the HVAC system components regardless of which zones the components may be associated with. Further, each system controller 106, each zone thermostat 158, and each zone sensor 160 may comprise a humidity sensor. As such, it will be appreciated that structure 200 may be equipped with a plurality of humidity sensors in a plurality of different locations. In some embodiments, a user may effectively select which of the plurality of humidity sensors is used to control operation of one or more of the HVAC systems 100.

With traditional HVAC systems, such as the HVAC system 100, a user typically uses a system controller, a zone thermostat, or a similar control mechanism to set a temperature near which the air in an occupied zone is to be maintained. That is, the user specifies a desired temperature setting, and the system provides heating and/or cooling such that the temperature in the occupied zone varies within a range of that setting.

In an embodiment, instead of or in addition to accepting a desired temperature setting as an input, an HVAC system control mechanism may accept an energy budget as an input. The system control mechanism then determines appropriate set points for temperature, humidity, and/or possibly other environmental factors such that energy usage for HVAC system operation at those set points over a given period of time is likely to remain within the given energy budget. Hereinafter, one or more settings for temperature, humidity, and/or other indoor comfort factors may be referred to generically as a single set point. As described in more detail below, the system controller may determine a set point based on the operating characteristics of the HVAC system, including how much energy the HVAC system is likely to use in maintaining the set point; the weather expected over the given time period; known or typical costs for energy usage in the location of the HVAC system; and other parameters.

In an embodiment, the system controller may display the set point that corresponds to a given energy budget. A user of the system controller may input a plurality of different energy budgets to learn their corresponding set points and may then select a desired combination of energy budget and set point. The system controller may then attempt to operate the HVAC system in such a manner that indoor comfort factors are maintained as closely as possible to the desired set point while the energy budget is also met. As used herein, the term “system controller” may refer to the component that receives an energy budget input, calculates an appropriate set point for the received energy budget input, and sets the HVAC system at the calculated set point, but it should be understood that some other type of component may perform these functions or that these functions may be divided among a plurality of different components.

In some embodiments, the energy budget may be specified directly in units of energy usage, such as kilowatt-hours of electricity usage, cubic feet of natural gas usage, or some other appropriate measure of energy usage. In other embodiments, the system controller may have knowledge of the typical monetary cost of electricity, natural gas, or other type of energy in the location of the HVAC system. In such cases, the system controller may allow a budget input in the form of a dollar amount or some other type of currency appropriate for its location. The system controller may then calculate an amount of energy usage that corresponds to the monetary input. In yet other embodiments, other types of energy budget inputs may be possible, such as a desired carbon footprint, and the system controller may be able to convert the input into an energy usage level. Hereinafter, any quantity that can be entered into a system controller and can be correlated to an amount of energy used by an HVAC system may be referred to as an energy budget. An energy budget for an HVAC system can be considered to be met when energy usage or energy costs for the HVAC system over a specified time period are less than or equal to the energy budget.

In an embodiment, a system controller may also receive an input specifying a period of time over which an energy budget should apply. For example, when a user of an HVAC system enters a monetary energy budget into a system controller, the user may also specify that the budgeted amount of money is to be spent over one month, one week, one day, or some other time period. The system controller may then break the specified time period into smaller increments, calculate a set point that is likely to meet the energy budget over a smaller increment, and set the set point at the calculated level throughout the smaller increment. After the smaller increment has passed, the system controller may determine the actual amount of energy used by the HVAC system over the smaller increment and compare the actual usage to the budgeted usage for the smaller increment. If the usage is above or below the budgeted usage by a specified amount, the system controller may adjust the usage in future smaller increments to bring the actual usage for the entire period back within budget.

As an example, a user may specify that up to three hundred dollars may be spent on heating for the upcoming month. The system controller may be aware that there are thirty days in the upcoming month and thus may calculate that ten dollars per day may be spent on heating. The system controller may then set the set point at a level that will result in approximately ten dollars being spent for heating on the first day of the month. At the end of the first day, the system controller may determine that, for example, twelve dollars were actually used in keeping the indoor comfort factors near the desired set point. The system controller may then recalculate the amount of money left in the budget for the month, recalculate the amount that can be spent each remaining day of the month, and reset the set point so that the recalculated amount is spent the next day.

If, instead, the system controller determines at the end of the first day that, for example, eight dollars were actually used in keeping the indoor comfort factors near the desired set point, the system controller may determine that more heating may be provided in the remainder of the month while still staying within budget and may adjust the set point accordingly. Alternatively, the set point may be maintained at its original level in an effort to keep energy usage below the energy budget for the entire month.

For each of the remaining days of the month, a similar procedure may be followed, wherein daily adjustments may be made to the energy budget and/or the set point in order to keep energy usage near the energy budget and the comfort factors near the set point. In other examples, other large time periods, other smaller incremental periods, and other dollar amounts could be used. Also, as described in more detail below, various means may be available for changing or overriding an energy budget and/or a set point during a given time period.

In an embodiment, responsive to receiving an input of energy budget information, the system controller may display the set point at which the HVAC system may operate in order to achieve that energy budget. The system controller may then provide an option for a user of the HVAC system to either accept the entered energy budget and corresponding set point or enter a different energy budget to discover the set point that corresponds to the different energy budget. The user may continue to enter energy budgets and observe the set points that have been determined to correspond to those energy budgets until an acceptable combination of energy budget and set point is found. The user may then accept that combination of energy budget and set point for a specified period of time.

Additionally or alternatively, responsive to receiving an input of a set point, the system controller may display the amount of energy that may be used or the amount of money that may be spent to operate the HVAC system at that set point. The user may continue to enter set points and observe the energy usages or money amounts that correspond to those set points until an acceptable combination of set point and energy usage or money amount is found.

The system controller may be or may have access to a programmable thermostat or a similar control mechanism that can offer different set points at different times of day. For example, such a control mechanism may allow a first set point at times when the building occupants are likely to be present in the building and a second set point at times when the building occupants are unlikely to be present in the building. In an embodiment, the system controller may take such programmable settings into account when calculating a set point. For example, if the budget is in danger of being exceeded during a heating season, the system controller may determine that energy expenditures may be brought back within the budget by decreasing the temperature more than usual during periods of unoccupancy. In other examples, the programmable settings may be taken into account in different ways in order to meet an energy budget.

The system controller may take a wide variety of information into account when determining an appropriate set point for a given energy budget. Such information may be stored in a memory component in the system controller, may be made available to the system controller via a network such as the internet, and/or may be provided to the system controller in some other manner. Such information may be provided to the system controller prior to the system controller's installation in an HVAC system and/or may be provided to the system controller after installation.

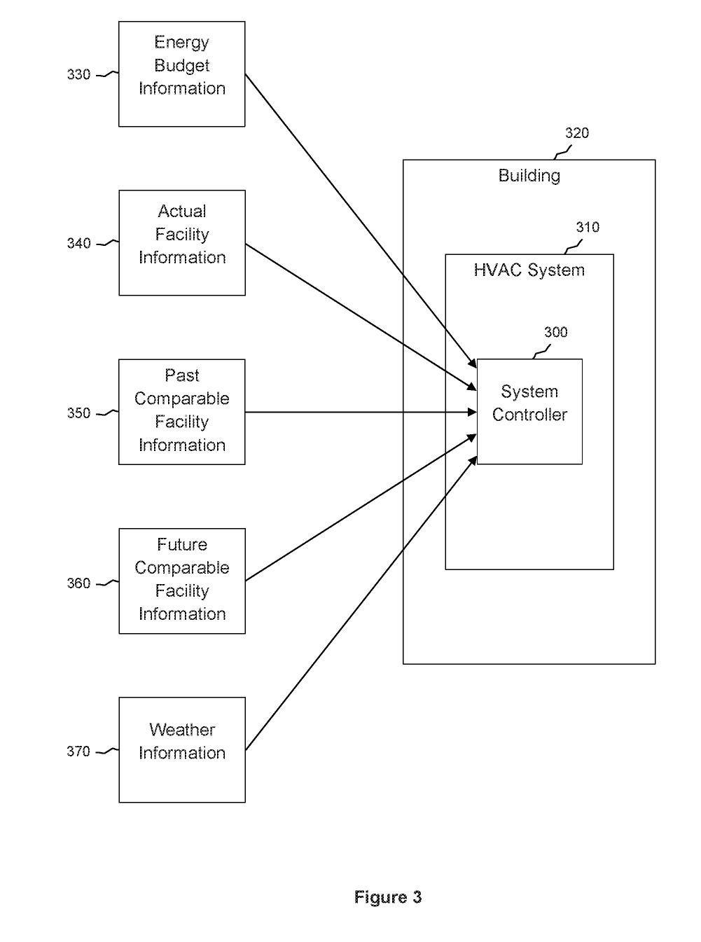

FIG. 3 illustrates several types of information that may be provided to a system controller 300 for use in determining a set point that can meet an energy budget for an HVAC system 310 and/or a building 320 associated with the HVAC system 310. The system controller 300 may be similar to the system controllers 106 of FIG. 1 and FIG. 2 or the indoor controller 124 of FIG. 1 or may be some other type of control mechanism or set of control mechanisms. The HVAC system 310 may be similar to the HVAC systems 100 of FIG. 1 and FIG. 2 or may be some other type of HVAC system. The building 320 may be similar to the structure 200 of FIG. 2 or may be some other type of structure. One of the types of information that may be provided to the system controller 300 is the energy budget information 330 discussed above, such as a desired energy budget, a desired set point, and/or a period of time over which the energy budget applies. Other types of input information may be referred to as actual facility information 340, past comparable facility information 350, future comparable facility information 360, and weather information 370.

Actual facility information 340 may refer to information that is known to apply to the HVAC system 310 and/or the building 320. One type of actual facility information 340 may be related to the actual HVAC system equipment with which the system controller 300 is associated. This type of actual facility information 340 may include the system type, such as a traditional air conditioning system, a heat pump system, a dual fuel system, or a gas furnace; the equipment size, such as the cooling capacity and the heating input or output capacity; the equipment efficiency levels, such as a Seasonal Energy Efficiency Rating (SEER), a Heating and Seasonal Performance Factor (HSPF), or an Annual Fuel Utilization Efficiency (AFUE); and/or equipment performance parameters provided by the manufacturer of the HVAC system equipment. Another type of actual facility information 340 may be related to the construction and/or size of the building 320 in which the HVAC system 310 is installed. Yet another type of actual facility information 340 may be energy cost rates in the region of the building 320, such as known or assumed kilowatt-hour rates for electricity. Still another type of actual facility information 340 may be general human factors information related to comfort in indoor environments. In other embodiments, other types of actual facility information 340 known to apply to the HVAC system 310 and/or the building 320 may be provided to the system controller 300 for use in determining a set point for a given energy budget.

Actual facility information 340 may also refer to information that the system controller 300 collects about its own operation and the operation of the HVAC system 310. For example, the system controller 300 may record how well its estimates of energy usage for calculated set points match the actual energy usages and may be able to refine its future calculations based on these records. The refinement of the calculations may also take into account information related to comparable HVAC systems, as described in more detail below. Additionally or alternatively, the building 320 may be equipped with a “smart” electric meter or gas meter that can record actual energy usage data. The system controller 300 may receive usage data from such a smart meter and adjust the operation of the HVAC system 310 accordingly in order to assist in maintaining an energy budget and/or a set point.

Comparable facility information may refer to information related to an HVAC system and/or a building similar to the HVAC system 310 and/or the building 320. Comparable facility information may be further categorized as past information or future information. Past comparable facility information 350 is information produced prior to the time the system controller 300 was placed into operation. Past facility comparable information 350 may include data equivalent to some or all of the information described above with regard to actual facility information 340 but, rather than applying to the actual HVAC system 310 and/or actual building 320, may apply to similar, previously existing HVAC systems and/or buildings.

Future comparable facility information 360 is information that is received by the system controller 300 after the time the system controller 300 is placed into operation. Future comparable facility information 360 may include data equivalent to some or all of the information described above with regard to actual facility information 340. Future comparable facility information 360 may include data that did not exist at the time the system controller 300 was installed and/or may include data that did exist at that time but was not yet available to the system controller 300.

Past comparable facility information 350 and future comparable facility information 360 may be gathered in several different ways. In some embodiments, a manufacturer of the HVAC system 310 may manufacture other HVAC systems that include system controllers capable of recording information related to the HVAC system and/or the building with which the system controller is associated. The manufacturer of the HVAC system 310 may be able to obtain such information from the other system controllers and apply the information to the system controller 300. For example, if a plurality of system controllers comparable to the system controller 300 are installed in HVAC systems and buildings comparable to the HVAC system 310 and the building 320, information about the operation of the other controllers may be applicable to the operation of the system controller 300. Such information may be available to the manufacturer of the HVAC system 310, and the manufacturer may use such information to determine appropriate behavior for the system controller 300 when the system controller 300 faces conditions similar to the conditions that existed when the information was collected. The manufacturer may provide such data to the system controller 300, and the system controller 300 may then use this data to determine an appropriate set point for a given energy budget.

As an example, a manufacturer may have gathered information from a plurality of system controllers indicating that, on average, a particular HVAC system uses a particular amount of energy at a particular set point under particular weather conditions. The manufacturer may conclude that the HVAC system 310 will use approximately the same amount of energy at a similar set point under similar weather conditions and may provide that information to the system controller 300. When an energy budget similar to that amount of energy is entered into the system controller 300 under similar weather conditions, the system controller 300 may determine that the HVAC system 310 should be set at that set point. The system controller 300 may also be able to extrapolate from that information to determine other appropriate set points when other energy budgets are entered under other weather conditions.

In other embodiments, past comparable facility information 350 and future comparable facility information 360 may be gathered in other ways. For example, tax records or other publicly available documents may be used to obtain information about a building such as its size and age. Alternatively or additionally, operational characteristics of an HVAC system may be manually recorded or obtained in some other manner.

Comparable facility information that is provided to the system controller 300 may be only past comparable facility information 350 or a combination of past comparable facility information 350 and future comparable facility information 360. Past comparable facility information 350 may be used without future comparable facility information 360 if there is a desire to keep the set point determination procedure relatively simple. That is, if nothing but past comparable facility information 350 is used, all such information may be stored in the system controller 300 prior to its deployment and the procedure for determining an appropriate set point need not take into account any information gathered after that time.

Both past comparable facility information 350 and future comparable facility information 360 may be used if the system controller 300 is capable of refining the procedure for determining an appropriate set point based on data received after its deployment. That is, the system controller 300 may have a processor and associated software that are capable of receiving newly generated data regarding the energy used by other HVAC systems at various set points under various weather conditions. The system controller 300 may then use such data, data collected by the system controller 300 about its own operation and the operation of the HVAC system 310, and data previously stored in the system controller 300 in determining an appropriate set point.

For example, before and/or after the HVAC system 310 is installed, a manufacturer may deploy a plurality of HVAC systems similar to HVAC system 310 in a plurality of geographic locations that experience disparate weather conditions. Each of the HVAC systems may record operational data under a variety of weather conditions and may provide that data to the manufacturer via a network connection or in some other manner. The manufacturer may then analyze this data to determine the typical energy usage for a particular type of HVAC system at a particular set point under a particular set of weather conditions. The manufacturer may then provide the results of such an analysis to the system controller 300. When the system controller 300 is given an energy budget input, the system controller 300 may use the information received from the manufacturer in its procedure for determining an appropriate set point to achieve that energy budget.

In some cases, the manufacturer may perform an analysis on the newly generated data and, based on the analysis, may send instructions to the system controller 300 that cause the system controller 300 to modify its procedure for determining a set point. In other cases, at least a portion of such an analysis may be performed by the system controller 300 responsive to receiving at least a portion of such information from the manufacturer. The system controller 300 may then be capable of modifying its procedure for determining a set point based, at least in part, on its own analysis of the data.

As mentioned above, the system controller 300 may take weather information 370 into account in determining an appropriate set point for a given energy budget. The weather information 370 may be any combination of historical weather data, current weather conditions, weather data collected after the time of deployment of the system controller 300, and/or a weather forecast. As an example, historical weather data may be stored in the system controller 300 prior to its deployment, and the system controller 300 may also be made aware of the current weather conditions. The system controller 300 may assume that energy usage under the current weather conditions will be similar to the energy usage under similar historical weather conditions and may determine a set point for a given energy budget accordingly.

As another example, the system controller 300 may take a weather forecast into account in determining a set point and/or an energy budget. That is, the system controller 300 may have access to weather forecast information via the internet or from some other source and may use such information to adjust a previously determined set point and/or allow itself to exceed the energy budget. For instance, the system controller 300 may receive an energy budget input, determine a set point over a particular time period that will meet that energy budget based on historical weather data and energy usage for that time period, and set the HVAC system 310 at that set point. The system controller 300 may then receive information indicating that a drastic change in the weather, such as a major cold front, is expected during that time period. Based on that forecast, the system controller 300 may lower the heating set point so that the energy budget is not exceeded when the weather turns colder. Alternatively, the system controller 300 may maintain the set point but exceed the energy budget.

In an embodiment, the system controller 300 may provide an option that allows a user to choose how the system controller 300 should respond to a forecast of a drastic change in the weather. Alternatively, the system controller 300 may perform such a response automatically. The response may depend on whether the forecast is considered favorable or unfavorable, where favorable may be defined as cooler than normal temperatures in a cooling season or warmer than normal temperatures in a heating season, and unfavorable may be defined as warmer than normal temperatures in a cooling season or cooler than normal temperatures in a heating season.

If the forecast is favorable, the system controller 300 may provide the user with at least two options. In a first option, the energy budget is maintained at the previously entered level. This option would allow the set point to be adjusted such that more comfort is provided, such as more heating in the winter or more cooling in the summer. In a second option, the set point is maintained at the calculated level. This option would provide the same comfort level as that previously selected but could use less energy than was budgeted.

If the forecast is unfavorable, the system controller 300 may provide the user with at least two similar options. In a first option, the energy budget is maintained at the previously entered level. This option may entail adjusting the set point such that less comfort is provided, such as less heating in the winter or less cooling in the summer. In a second option, the set point is maintained at the calculated level. This option would provide the same comfort level as that previously selected but could use more energy than was budgeted.

When a forecast is favorable or unfavorable, the system controller 300 may automatically perform a default action rather than asking the user how to respond to the forecast. That is, the system controller 300 may always maintain the energy budget at the previously given level or may always maintain the set point at the previously calculated level when a drastic change in the weather is expected. The system controller 300 may then inform the user that the default action has been taken and may give the user an opportunity to override the default action.

Additionally or alternatively, if the forecast for the beginning of a time period is unfavorable but the forecast for the end of the time period is favorable, the system controller 300 may allow the energy budget to be exceed at the beginning of the time period, knowing that the favorable weather at the end of the time period is likely to allow the overall budget for the entire time period to be met. If the forecast for the beginning of a time period is favorable but the forecast for the end of the time period is unfavorable, the system controller 300 may attempt to meet the overall budget for the entire time period by decreasing energy usage at the beginning of the time period, knowing that more energy may be needed at the end of the time period. The system controller 300 may take such actions automatically or may ask the user if such actions should be taken.

In an embodiment, similar options may apply when the actual energy usage near the beginning of a time period may result in usage over the entire time period that is significantly higher or significantly lower than the usage that was budgeted for the entire time period. For example, a user may enter an energy budget for a one-month period into the system controller 300. If the actual weather conditions near the beginning of the month have been favorable, energy usage near the beginning of the month may be below budget. In such a case, the previously entered energy budget and set point may be maintained, and less energy than budgeted may be used over the entire month as a result. Alternatively, more comfort may be provided in the remainder of the month by adjusting the set point such that the entire energy budget for the month is used. If the actual weather conditions near the beginning of the month have been unfavorable, energy usage near the beginning of the month may be above budget. In such a case, the previously entered energy budget and set point may be maintained, and more energy than budgeted may be used over the entire month. Alternatively, the set point may be adjusted such that the energy budget for the month is not exceeded, but less comfort may be provided in the remainder of the month as a result.

In an embodiment, the system controller 300 may automatically notify the user that the actual energy usage for the first portion of a time period has been significantly higher or significantly lower than expected and that the user may wish to make adjustments to the energy budget and/or the set point as a result. The user may then choose to adjust the energy budget and/or the set point as described above. Additionally or alternatively, the system controller 300 may provide a capability for the user to manually check the energy usage for an initial portion of a time period and to adjust the energy budget and/or the set point as desired for the remainder of the time period.

In an embodiment, the system controller 300 may provide the capability for a user to manually, temporarily override an energy budget and its associated set point when unusual circumstances occur. For example, a homeowner who has invited a large number of guests to the home during a cooling season may wish to temporarily override the energy budget to provide additional cooling to overcome the body heat generated by the additional occupants. As another example, during a heating season, the homeowner may host a guest who is uncomfortable with the heating set point selected by the homeowner. In such a case, the homeowner may temporarily override the energy budget to allow additional heating to be provided while the guest is present.

In this way, a user could, in effect, “buy” more comfort for a period of time. That is, the energy budget and/or the set point are not necessarily held constant throughout a budgeted time period, and either or both may be changed for some time. When an extra amount of comfort is temporarily “bought” in this manner, the HVAC system 310 may not return to the original set point, and thus a change in the energy budget may be entailed.

In an embodiment, responsive to a user entering a set point for an override, the system controller 300 may display a predicted cost for the override. For example, if a user entered an input into the system controller 300 indicating a desire to change a cooling set point from 78° F. to 72° F. for the next day, the system controller may display that such a change would cost, for instance, $8.57. After learning the predicted cost for an override, the user may accept the override set point or enter a different override set point to learn the predicted cost for the different override set point.

When the user wishes to end an override, the user may enter an input into the system controller 300 indicating that the override should end. In an embodiment, the system controller 300 may then automatically recalculate and readjust the set point to a level different from the setting prior to the override in order to bring the energy expenditure back within the energy budget. For example, during a heating season, the system controller 300 may determine that a 70° F. temperature set point will meet a given energy budget and may operate the HVAC system at that set point. A temporary energy budget override may later be used to provide additional heating to achieve a higher set point for a period of time within the energy budget period. At the end of the override, the system controller 300 may recalculate and reset the temperature set point to, for instance, 68° F. for the remainder of the energy budget period in order to compensate for the temporary use of additional heat and meet the original energy budget.

In an alternative embodiment, the system controller 300 may ignore the temporary override with respect to the energy budget. That is, after receiving an indication that the override has ended, the system controller 300 may return the set point to its level prior to the override, ignore the extra energy used during the override in the calculations of set points for the remainder of the energy budget period, and allow the energy budget to be exceeded for the entire energy budget period due to the override. The system controller 300 may perform one of these alternatives as a default and/or may provide an option for a user to select one of these alternatives.

In addition, the system controller 300 may provide the capability for operating the HVAC system 310 in the traditional manner. That is, a user may simply enter a desired set point, and the HVAC system 310 will cycle on and off in order to maintain that set point without taking an energy budget into consideration.

In an embodiment, rather than an energy budget applying only to the HVAC system 310, the energy budget may apply to the entire building 320. That is, energy usage over an energy budget period may be known or assumed for all energy-using components in the building 320 other than the HVAC system 310. A set point may then be calculated for the HVAC system 310 such that the total energy usage for the HVAC system 310 plus the non-HVAC components over that period is within a given energy budget. Non-HVAC system energy usage may be determined by, for example, user-entered data about the actual energy usage of other energy-using components, such as appliances and lights; user-entered estimates of non-HVAC system energy usage; historical energy usage as determined by, for instance, automated system monitoring or automated retrieval of historical data; actual or estimated energy usage for comparable buildings; or other sources. Such a full-building energy budget may be more meaningful to a user of the system controller 300 than an HVAC system-based energy budget since the user is more likely to know the total energy usage or energy cost of the building 320, as indicated by an electricity bill for instance, than to know the energy usage of the HVAC system 310 alone.

In an embodiment, an energy budget may be met by operating one or more of the components of the HVAC system 310 at a reduced capacity. That is, in the traditional manner of operating an HVAC system, a temperature set point is maintained by cycling the HVAC system on and off for varying lengths of time. In an embodiment, a temperature set point is instead maintained by temporarily reducing the energy usage of at least one component of the HVAC system 310. For example, the speed of a fan or a motor may be cycled between full capacity and a reduced capacity in order to maintain a temperature set point.

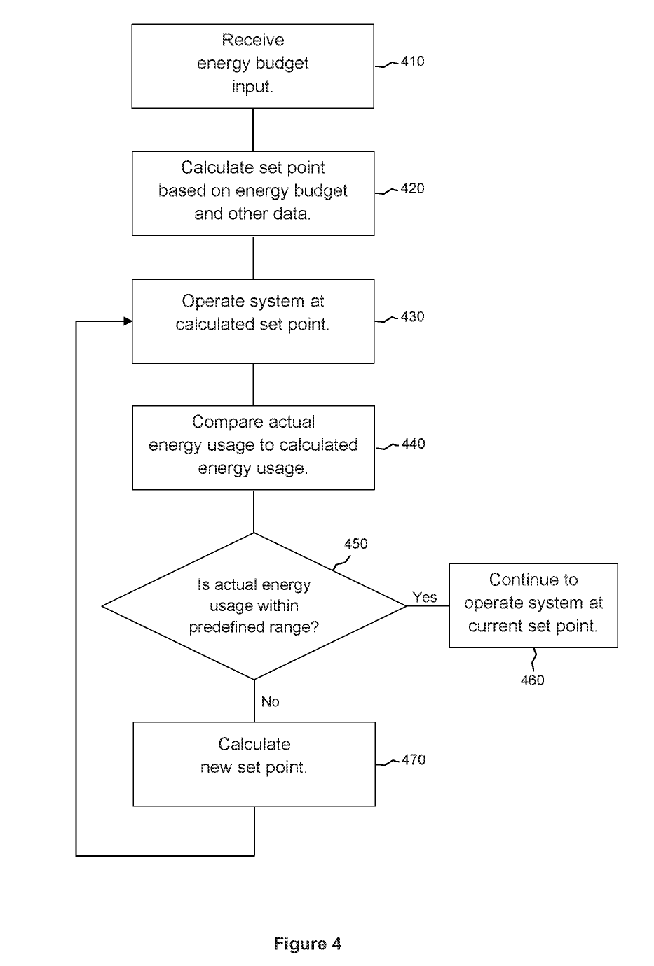

FIG. 4 is a flowchart illustrating an embodiment of a method for operating an HVAC system. At block 410, a system controller for the HVAC system receives an energy budget input. The energy budget may be an amount of energy to be used by the HVAC system over a specified period of time, an amount of money to be spent in operating the HVAC system over a specified period of time, an amount of money to be spent over a specified period of time for energy in a building in which the HVAC system operates, or some other type of energy budget information. At block 420, the system controller calculates a set point for the HVAC system that will cause an amount of energy used in operating the HVAC system over the specified period of time to meet the energy budget. The calculation may be based on the energy budget and other data, such as HVAC system operating parameters, weather information, and/or electricity cost rates. At block 430, the system controller causes the HVAC system to operate at the calculated set point. At block 440, after a portion of the time period has elapsed, the system controller compares the actual energy usage over the portion of the time period to the amount of energy that was calculated to be used over that portion of the time period.

At block 450, the system controller determines whether the actual energy usage was within a predefined range of the calculated energy usage. For example, the predefined range may be a specified number of dollars above or below a calculated number of dollars, a specified amount of electricity above or below a calculated amount of electricity, or some other specified range. The range may be set by the manufacturer of the HVAC system, the user of the HVAC system, or some other entity. If the actual energy usage was within the predefined range of the calculated energy usage, then at block 460, the system controller continues to operate the HVAC system at the current set point. If the actual energy usage was not within the predefined range of the calculated energy usage, then at block 470, the system controller calculates a new set point that may allow the energy usage for the entire time period to meet the energy budget. The procedure then returns to block 430, where the system controller causes the HVAC system to operate at the new set point.

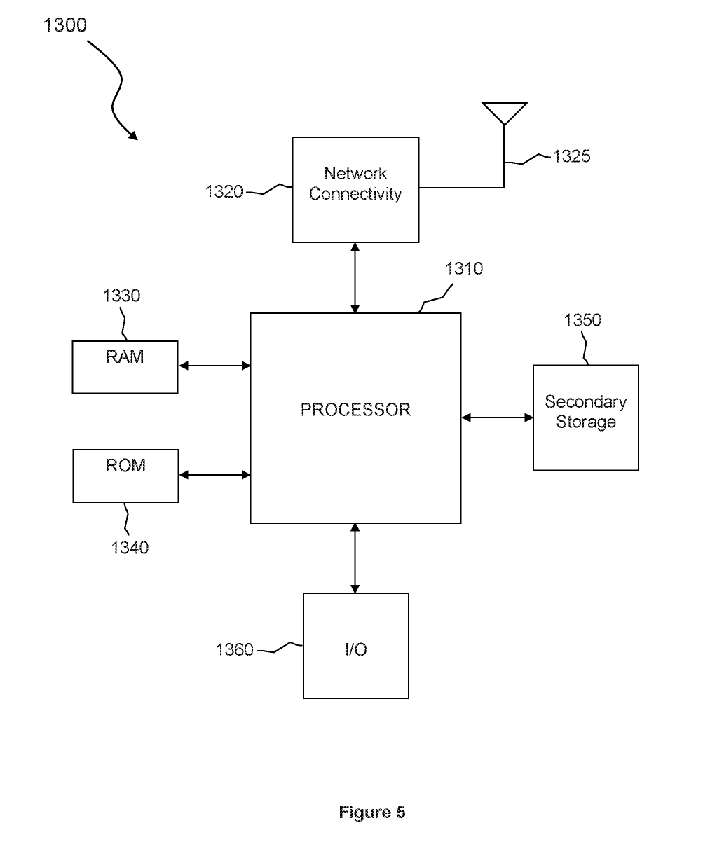

FIG. 5 illustrates a typical, general-purpose processor (e.g., electronic controller or computer) system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, optical disk, or other drive). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form of, for example, a computer data baseband signal or a signal embedded in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs or instructions that are loaded into RAM 1330 when such programs are selected for execution or information is needed.

The I/O devices 1360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 1325 might be considered a component of the I/O devices 1360 instead of or in addition to being a component of the network connectivity devices 1320.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as “comprises”, “includes”, and “having” should be understood to provide support for narrower terms such as “consisting of”, “consisting essentially of”, and “comprised substantially of”. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A method for operating a heating, ventilation, and/or air conditioning (HVAC) system, the method comprising:
receiving an input of a time period;
receiving an input of a first humidity value;
receiving an input of an energy cost;
estimating a cost of operating the HVAC system to maintain the first humidity value during the time period;
receiving an input of a second humidity value; and
estimating a cost of operating the HVAC system to maintain the second humidity value during the time period.

2. The method of claim 1, further comprising determining a set point for the time period, wherein the set point is based on comfort factors comprising humidity and temperature.

3. The method of claim 1, further comprising receiving inputs of a plurality of different energy budgets; displaying a set point to achieve a specified energy budget in response to the receiving inputs of a plurality of different energy budgets; and providing an option for a user of the HVAC system to either accept an entered energy budget and corresponding set point or enter a different energy budget to discover a set point that corresponds to the different energy budget.

4. The method of claim 3, further comprising displaying a plurality of set points corresponding to the plurality of different energy budgets.

5. The method of claim 1, further comprising dividing the time period into increments and calculating a set point to satisfy an energy budget for each increment.

6. The method of claim 5, further comprising comparing an actual amount of energy used during each increment to a budgeted usage of energy for each increment.

7. The method of claim 6, further comprising adjusting energy usage for future increments to bring an actual energy usage for the time period back within an energy budget for the time period.

8. The method of claim 7, further comprising calculating a monetary amount used from the energy budget for the time period; calculating a monetary amount remaining in the energy budget for the time period; calculating a monetary amount available in the energy budget for a remainder of the time period; and determining a set point to expend the monetary amount available during the remainder of the time period.

9. The method of claim 2, further comprising offering different set points at different times of day.

10. The method of claim 1, further comprising receiving facility information comprising types of systems; HVAC system equipment size; HVAC system equipment performance parameters provided by a manufacturer of the HVAC system equipment; and size of a building in which the HVAC system is installed, wherein the facility information comprises past facility information and future facility information.

11. The method of claim 1, further comprising receiving energy usage data from an electric meter or a gas meter; and adjusting operation of the HVAC system to maintain an energy budget for the time period.

12. The method of claim 1, further comprising storing historical weather data.

13. The method of claim 12, further comprising adjusting a previously determined set point based on the historical weather data.

14. The method of claim 1, further comprising providing an option that allows a user to choose an HVAC system response to a weather forecast.

15. The method of claim 1, further comprising performing a default action in response to receiving a weather forecast.

16. A system controller for a heating, ventilation, and/or air conditioning (HVAC) system, the system controller comprising:
a processor configured to:
receive an input of a time period;
receive an input of a first humidity value;
receive an input of an energy cost;
estimate a cost of operating the HVAC system to maintain the first humidity value during the time period;
receive an input of a second humidity value; and
estimate a cost of operating the HVAC system to maintain the second humidity value during the time period.

17. The system controller of claim 16, wherein the processor is further configured to notify a user that actual energy usage for a first portion of the time period is higher or lower than expected, and suggesting to the user to make adjustments to an energy budget and/or a set point.

18. The system controller of claim 17, wherein the processor is further configured to allow the user to check the actual energy usage for the first portion of the time period and to adjust the energy budget and/or the set point for a remainder of the time period.

19. The system controller of claim 18, wherein the processor is further configured to allow the user to override the energy budget and the set point.

20. The system controller of claim 19, wherein the actual energy usage comprises energy usage for the HVAC system over the time period plus energy usage for non-HVAC components over the time period.
